(19) United States
(12) Patent Application Publication
(10) Pub. No.: US 2018/0225681 A1
(43) Pub. Date: Aug. 9, 2018

(54) USER INFORMATION ESTIMATION SYSTEM, USER INFORMATION ESTIMATION METHOD, AND USER INFORMATION ESTIMATION PROGRAM

(71) Applicant: NEC CORPORATION, Tokyo (JP)

(72) Inventors: Ryohei FUJIMAKI, Tokyo (JP); Takeshi ISHIHARA, Tokyo (JP)

(21) Appl. No.: 15/750,349

(22) PCT Filed: Jul. 26, 2016
(86) PCT No.: PCT/JP2016/003458

§ 371 Date: Feb. 5, 2018

Related U.S. Application Data
(60) Provisional application No. 62/201,647, filed on Aug. 6, 2015.

(51) Int. Cl. G06Q 30/02; G06N 99/00

(52) U.S. Cl. CPC G06Q 30/0201; G06N 99/005

(57) ABSTRACT

Provided is a user information estimation system capable of estimating demographic information about a user of a prepaid mobile terminal. An estimation model generation means 21 generates, on the basis of information relating to a mobile terminal in which demographic information about a user is known, and the demographic information, an estimation model with demographic information as an objective variable, and information relating to a mobile terminal as an explanatory variable. An estimation means 22 applies information relating to a prepaid mobile terminal to the estimation model, to calculate an estimated value of demographic information about a user of the prepaid mobile terminal.

### TECHNICAL FIELD

The present invention relates to a user information estimation system, a user information estimation method, and a user information estimation program that estimate demographic information about a user of a prepaid mobile terminal.

### BACKGROUND ART

A technology that estimates an item related to a prepaid mobile terminal is described in PTL 1. In a method described in PTL 1, a usage charge is estimated on the basis of a usage history recorded in a prepaid card mounted on the mobile terminal. That is, in the method described in PTL 1, the usage charge of the prepaid mobile terminal is an estimation target.

### CITATION LIST

### Patent Literature

PTL 1: Japanese Patent Application Laid-Open No. 2008-33803

### SUMMARY OF INVENTION

### Technical Problem

A communication carrier obtains demographic information (for example, age and gender) about a user of a postpaid mobile terminal at the time of contract with the user, so that the communication carrier can grasp the demographic information about the user of the postpaid mobile terminal. Incidentally, here, the age and gender are exemplified as examples of the demographic information; however, the demographic information includes the occupation and annual income, as other examples.

However, the communication carrier cannot grasp demographic information about a user of the prepaid mobile terminal (for example, age and gender).

In the method described in PTL 1, the usage charge of the prepaid mobile terminal can be estimated, but the demographic information about the user of the prepaid mobile terminal cannot be estimated.

In addition, the communication carrier can grasp an actual value of the monthly usage charge of the prepaid mobile terminal, but cannot grasp the demographic information about the user of the prepaid mobile terminal, as described above.

Therefore, an object of the present invention is to provide a user information estimation system, a user information estimation method, and a user information estimation program capable of estimating the demographic information about the user of the prepaid mobile terminal.

### Solution to Problem

A user information estimation system according to the present invention includes: an estimation model generation means that generates, on the basis of information relating to a mobile terminal in which demographic information about a user is known, and the demographic information, an estimation model with demographic information as an objective variable, and information relating to a mobile terminal as an explanatory variable; and an estimation means that applies information relating to a prepaid mobile terminal to the estimation model, to calculate an estimated value of the demographic information about the user of the prepaid mobile terminal.

In addition, a user information estimation method according to the present invention includes: generating, on the basis of information relating to a mobile terminal in which demographic information about a user is known, and the demographic information, an estimation model with demographic information as an objective variable, and information relating to a mobile terminal as an explanatory variable; and applying information relating to a prepaid mobile terminal to the estimation model, to calculate an estimated value of demographic information about a user of the prepaid mobile terminal.

In addition, a user information estimation program according to the present invention causes a computer to execute: estimation model generation processing that generates, on the basis of information relating to a mobile terminal in which demographic information about a user is known, and the demographic information, an estimation model with demographic information as an objective variable, and information relating to a mobile terminal as an explanatory variable; and estimation processing that applies information relating to a prepaid mobile terminal to the estimation model, to calculate an estimated value of demographic information about a user of the prepaid mobile terminal.

### Advantageous Effects of Invention

According to the present invention, the demographic information about the user of the prepaid mobile terminal can be estimated.

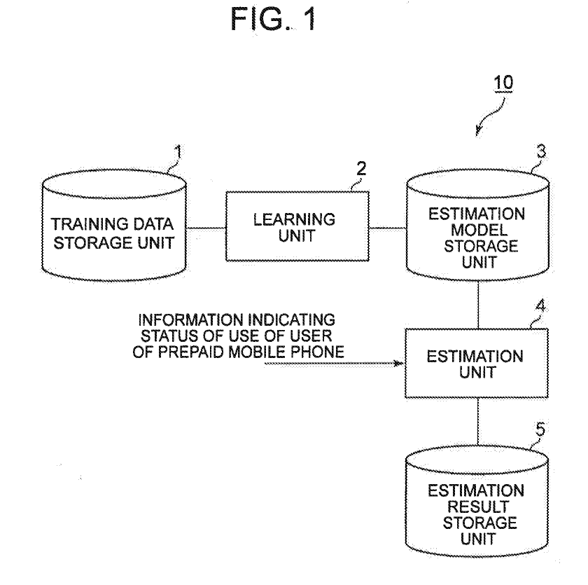

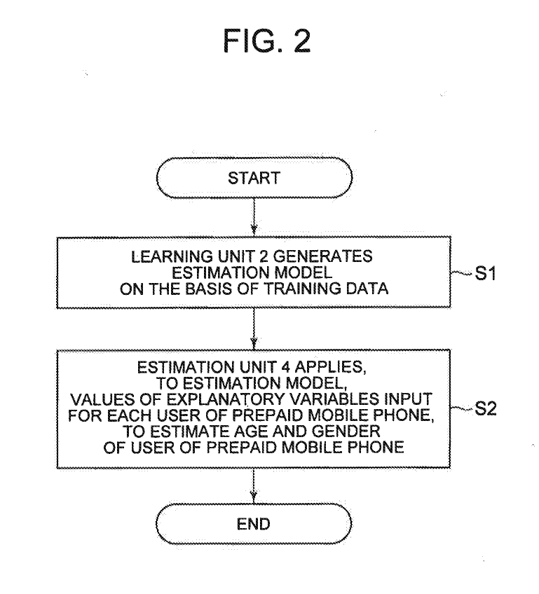

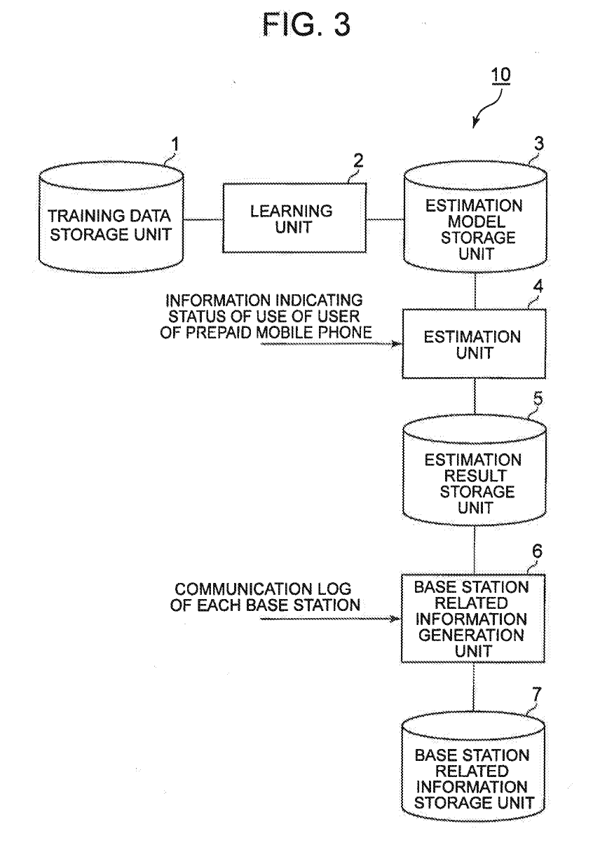

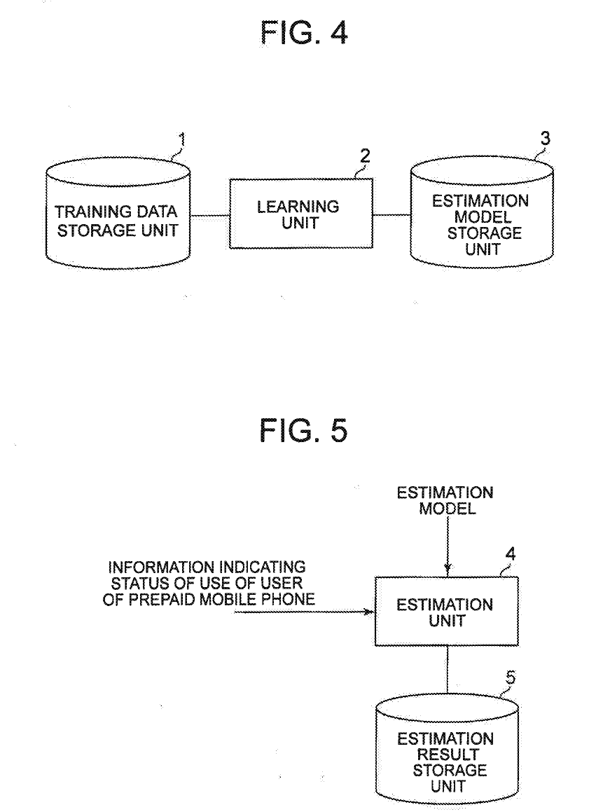

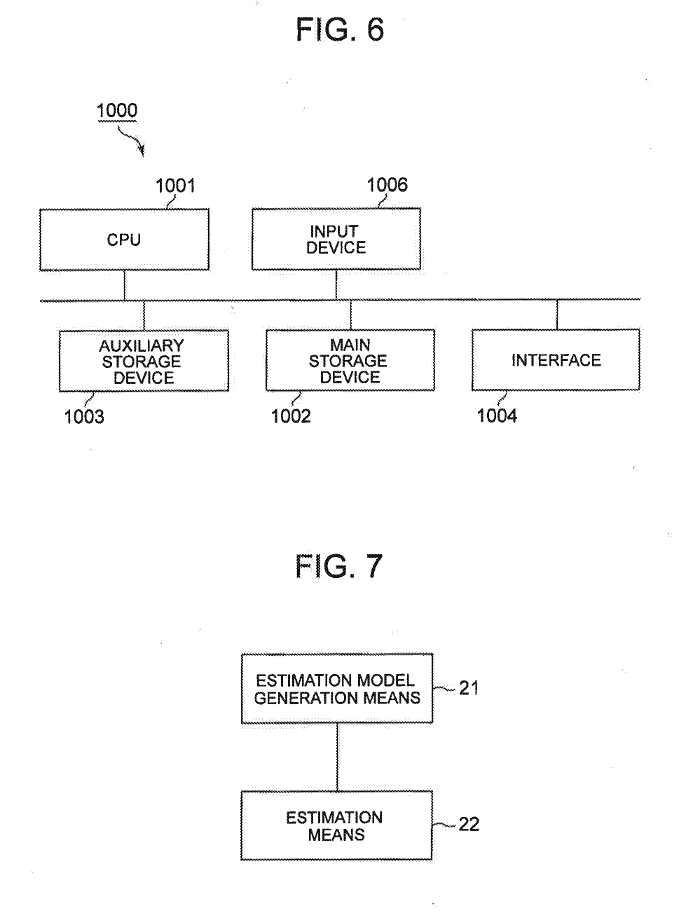

### BRIEF DESCRIPTION OF DRAWINGS

[FIG. 1] It depicts a block diagram illustrating an example of a user information estimation system of a first exemplary embodiment of the present invention.

[FIG. 2] It depicts a flowchart illustrating an example of processing progress of the first exemplary embodiment of the present invention.

[FIG. 3] It depicts a block diagram illustrating an example of a user information estimation system of a second exemplary embodiment of the present invention.

[FIG. 4] It depicts a block diagram illustrating an example of a learning system.

[FIG. 5] it depicts a block diagram illustrating an example of an estimation system.

[FIG. 6] It depicts a schematic block diagram illustrating a configuration example of a computer according to exemplary embodiments of the present invention.

[FIG. 7] It depicts a block diagram illustrating an outline of a user information estimation system of the present invention.

### DESCRIPTION OF EMBODIMENTS

Hereinafter, exemplary embodiments of the present invention will be described with reference to the drawings.

In the exemplary embodiments of the present invention shown below, a case will be described, as an example, in which user's age and gender are estimated as demographic information about a user of a prepaid mobile terminal.

Incidentally, the user of the prepaid mobile terminal preferably accepts that the demographic information (the age and gender, in the exemplary embodiments shown below) is estimated.

In addition, in the exemplary embodiments of the present invention shown below, a case will be described, as an example, in which the prepaid mobile terminal is a prepaid mobile phone, and a postpaid mobile terminal is a postpaid mobile phone.

In addition, in the exemplary embodiments shown below, an estimation model for estimating the demographic information (age and gender) of the user of the prepaid mobile phone is generated by machine learning.

Then, a variable used as a parameter in execution of estimation using the estimation model is referred to as an “explanatory variable”. In addition, a variable representing an estimation target is referred to as an “objective variable”.

In the exemplary embodiments shown below, information indicating a status of use of a mobile phone is used as the explanatory variable. The information indicating the status of use of the mobile phone can also be referred to more specifically as information indicating usage history of the mobile phone. In addition, in the exemplary embodiments shown below, the age and gender correspond to the objective variable. Incidentally, information relating to the mobile terminal may be used as the explanatory variable, and the explanatory variable is not limited to the information indicating the status of use of the mobile phone (mobile terminal).

### First Exemplary Embodiment

FIG. 1 is a block diagram illustrating an example of a user information estimation system of a first exemplary embodiment of the present invention. A user information estimation system 10 of the present exemplary embodiment includes a training data storage unit 1, a learning unit 2, an estimation model storage unit 3, an estimation unit 4, and an estimation result storage unit 5.

The training data storage unit 1 is a storage device that stores training data used for learning an estimation model of demographic information about a user of a prepaid mobile phone. Hereinafter, an example will be described of the training data stored by the training data storage unit 1.

The training data storage unit 1 stores a value of an item corresponding to the objective variable of a user of a postpaid mobile phone in association with the user of the postpaid mobile phone. For example, in a case where the objective variable is “age”, the training data storage unit 1 stores a user ID of the user of the postpaid mobile phone and the age of the user in association with each other. In addition, for example, in a case where the objective variable is “gender”, the training data storage unit 1 stores the user ID of the user of the postpaid mobile phone and the gender of the user in association with each other. The number of objective variables is not limited to one, and two or more objective variables may exist. For example, only the “age” or only the “gender” may be used as the objective variable, or each of the “age” and the “gender” may be used as the objective variable.

The training data storage unit 1 may store the user ID of the user of the postpaid mobile phone, and the value of the item corresponding to the objective variable for each user, in a matrix (user ID, age, gender), for example. The number of items, such as the “age” and the “gender” included in the matrix, is determined depending on the number of objective variables. In addition, in the following description, a case will be described, as an example, in which male is represented by “1”, and female is represented by “−1”, in representation of the gender. For example, it is assumed that the user ID of the user of the postpaid mobile phone is “ID1”, and the age and gender of the user are respectively 23 and female. In this case, the training data storage unit 1 only needs to store a matrix (ID1, 23, −1) for the user. For example, the training data storage unit 1 stores the matrix as described above for many users using the postpaid mobile phones. In addition, a communication carrier acquires demographic information such as the age and gender at the time of contract with the user of the postpaid mobile phone, so that the communication carrier can grasp the age, gender, and the like of the user of the postpaid mobile phone. Therefore, by using information grasped by the communication carrier, it is possible to store the matrix as described above in the training data storage unit 1, for many users using the postpaid mobile phones.

Similarly, the training data storage unit 1 stores a value of an item corresponding to the explanatory variable of the user of the postpaid mobile phone in association with the user of the postpaid mobile phone. In the present invention, the information indicating the status of use of the mobile phone is used as the explanatory variable. More specific examples of the information indicating the status of use of the mobile phone include “number of voice calls in the past month”, “voice call duration in the past month”, and “number of mail transmissions in the past month”. The specific example of the information indicating the status of use is not limited thereto. In addition, the number of explanatory variables is not particularly limited. For example, each of the “number of voice calls in the past month”, the “voice call duration in the past month”, and the “number of mail transmissions in the past month” exemplified may be used as the explanatory variable. The training data storage unit 1 only needs to store the user ID of the user of the postpaid mobile phone and the value of the item corresponding to the explanatory variable of the user in association with each other.

The training data storage unit 1 may store the user ID of the user of the postpaid mobile phone, and the value of the item corresponding to each explanatory variable, for each user, in a matrix (user ID, number of voice calls in the past month, voice call duration in the past month, number of mail transmissions in the past month). For example, it is assumed that the user ID of the user of the postpaid mobile phone is “ID1”, and the “number of voice calls in the past month”, the “voice call duration in the past month”, and the “number of mail transmissions in the past month” of the user are respectively “50 times”, “100 minutes”, and “75 times”. In this case, the training data storage unit 1 only needs to store a matrix (ID1, 50, 100, 75) for the user. For example, the training data storage unit 1 stores the matrix as described above for many users Using the postpaid mobile phones. Incidentally, the information indicating the status of use of the mobile phone, such as the “number of voice calls in the past month”, the “voice call duration in the past month”, and the “number of mail transmissions in the past month”, and the user ID can be extracted from call detail record (CDR) data retained by the communication carrier. By extracting the value of the item corresponding to the explanatory variable from the CDR data retained by the communication carrier, it is possible to store the matrix as described above in the training data storage unit 1, for many users using the postpaid mobile phones. Here, it is assumed that the communication carrier grasps each of the user ID of the user of the postpaid mobile phone and the user ID of the user of the prepaid mobile phone. Incidentally, the value of the item corresponding to each explanatory variable may be a value extracted from data other than the CDR data (for example, a communication log of a base station).

The user ID stored together with the value of the item corresponding to the objective variable, and the user ID stored together with the value of the item corresponding to each explanatory variable, are common, and are the user ID of the user of the postpaid mobile phone.

A set of information in which the user ID of the user of the postpaid mobile phone and the value of the item corresponding to the objective variable of the user are associated with each other, and a set of information in which the user ID of the user of the postpaid mobile phone and the value of the item corresponding to each explanatory variable of the user are associated with each other, are training data.

The learning unit 2 uses the training data to generate an estimation model with the “age” as the objective variable, and an estimation model with the “gender” as the objective variable, by machine learning. The estimation model is a model for applying a value of the explanatory variable to the model, to derive a value of the objective variable (that is, an estimation result). In other words, the estimation model is information indicating a regularity that holds between the explanatory variable and the objective variable.

A method for generating the estimation model is not particularly limited, and a known method may be used, for example, regression analysis.

The learning unit 2 may generate only the estimation model with the “age” as the objective variable, or may generate only the estimation model with the “gender” as the objective variable. In addition, the learning unit 2 may generate both the estimation model with the “age” as the objective variable and the estimation model with the “gender” as the objective variable.

In a case where the learning unit 2 generates both the estimation model with the “age” as the objective variable and the estimation model with the “gender” as the objective variable, information in which the user ID of the user of the postpaid mobile phone and the age and gender of the user are associated with each other, is included in the training data. In addition, in a case where the learning unit 2 generates only the estimation model with the “age” as the objective variable, the value of the gender of the user of the postpaid mobile phone does not have to be included in the training data. In addition, in a case where the learning unit 2 generates only the estimation model with the “gender” as the objective variable, the value of the age of the user of the postpaid mobile phone does not have to be included in the training data. In the following description, a case will be described, as an example, in which the learning unit 2 generates both the estimation model with the “age” as the objective variable and the estimation model with the “gender” of the objective variable.

An example wilt be described of the estimation model with the “age” as the objective variable generated by the learning unit 2. The estimation model is expressed by, for example, an equation (1) shown below.

y=Xw (1)

The y shown in the equation (1) is a column vector having the same number of components as the number of users of the prepaid mobile phones for which the ages are estimated. That is, when the number of users of the prepaid mobile phones for which the ages are estimated is n, y=(a₁, a₂, . . . , aₙ)^{T}. The a₁, a₂, . . . , and aₙ are objective variables representing ages of respective users of the prepaid mobile phones.

In a case where the number of users of the prepaid mobile phones for which the ages are estimated is n, and the number of explanatory variables is m, the X shown in the equation (1) is a matrix of n rows and in columns. In rows of the X, the explanatory variables are arranged, respectively. In addition, the w shown in the equation (1) is a column vector having weights corresponding to respective explanatory variables as components. As described above, in a case where the number of explanatory variables is m, w=(w₁, w₂, . . . , wₘ)^{T}.

For example, it is assumed that the “number of voice calls in the past month”, the “voice call duration in the past month”, and the “number of mail transmissions in the past month” are explanatory variables, and the three explanatory variables are x₁, x₂, and x₃. In this case, w=(w₁, w₂, . . . , w₃)^{T}, and the w₁, w₂, and w₃ are weights respectively corresponding to the x₁, x₂, and x₃. In a case of this example, the equation (1) is expressed as an equation (2) below.

[Mathematical Expression 1]

$$( \begin{matrix}{a}_{1} \\ {a}_{2} \\ ⋮ \\ {a}_{n}\end{matrix} ) = ( \begin{matrix}{x}_{1} & {x}_{2} & {x}_{3} \\ {x}_{1} & {x}_{2} & {x}_{3} \\ ⋮ & ⋮ & ⋮ \\ {x}_{1} & {x}_{2} & {x}_{3}\end{matrix} ) ( \begin{matrix}{w}_{1} \\ {w}_{2} \\ {w}_{3}\end{matrix} ) \qquad ( 2 )$$

Next, an example will be described of the estimation model with the “gender” as the objective variable generated by the learning unit 2. The estimation model is expressed by, tier example, an equation (3) shown below.

y=logistic(Xw) (2)

The X and w shown in the equation (2) are the same as the X and w shown in the equation (1). In addition, logistic( ) is a logistic regression function.

The y shown in the equation (2) is a column vector having the same number of components as the number of users of the prepaid mobile phones for which the genders ares estimated. That is, when the number of users of the prepaid mobile phones for which the genders are estimated is n, y=(s₁, s₂, . . . , sₙ)^{T}. The s₁, s₂, . . . , sₙ are objective variables representing genders of respective users of the prepaid mobile phones, and each have a value of “1” or “−1” in estimation of the gender. When the value of the objective variable is “1”, it means that the estimation result of the gender is the “male”, and when the value of the objective variable is “−1”, it means that the estimation result of the gender is “female”. However, at the time when the learning unit 2 generates the estimation model, the value of the objective variable has not been determined.

The learning unit 2 uses the training data to generate the estimation model with the “age” as the objective variable (for example, the equation (1)), and the estimation model with the “gender” as the objective variable (for example, the equation (3)), by machine learning. As described already, the method for generating the estimation model is not particularly limited, and a known method may be used, for example, regression analysis.

The learning unit 2 stores the estimation model generated on the basis of the training data, in the estimation model storage unit 3. The estimation model storage unit 3 is a storage device that stores the estimation model generated by the learning unit 2.

The estimation unit 4 uses the estimation model generated by the learning unit 2 to estimate the demographic information about the user of the prepaid mobile phone (the age and gender, in the present exemplary embodiment).

The information indicating the status of use of the prepaid mobile phone by the user of the prepaid mobile phone is input, as the value of the explanatory variable, to the estimation unit 4. In the present example, it is assumed that, in the estimation model, the “number of voice calls in the past month”, the “voice call duration in the past month”, and the “number of mail transmissions in the past month” are respectively the explanatory variables x₁, x₂, and x₃. In this case, for each user of the prepaid mobile phone for which the age and gender are estimated, information in which the user ID and values of these explanatory variables are associated with each other, is input to the estimation unit 4.

As described above, the information indicating the status of use of the mobile phone, such as the “number of voice calls in the past month”, the “voice call duration in the past month”, and the “number of mail transmissions in the past month”, and the user ID can be extracted from the CDR data. In addition, the communication carrier grasps each of the user ID of the user of the postpaid mobile phone, and the user ID of the user of the prepaid mobile phone. Therefore, for each user of the prepaid mobile phone, the information in which the user ID and the values of the explanatory variables are associated with each other, can be input to the estimation unit 4.

The estimation unit 4 assigns, to the equation (1), the values of the explanatory variables input for each user, to calculate values of the components a₁, a₂, . . . , and aₙ of the vector y of the equation (1). In the present example, specifically, the equation (1) is expressed as the equation (2). The estimation unit 4 assigns values of x₁, x₂, and x₃ of a user of the first prepaid mobile phone, values of x₁, x₂, and x₃ of a user of the second prepaid mobile phone, . . . , and values of x₁, x₂, and x₃ of a user of the n-th prepaid mobile phone, respectively to components of the first row of the matrix X, components of the second row of the matrix X, . . . , and components of the n-th row of the matrix X, to calculate the values of the components a₁, a₂, . . . , and aₙ of the vector y. The a₁, a₂, . . . , and aₙ are the objective variables representing the ages of the respective users of the prepaid mobile phones, so that the values of the a₁, a₂, . . . , and aₙ calculated are estimated values of the ages of the respective users of the prepaid mobile phones.

Similarly, the estimation unit 4 assigns, to the equation (3), the values of the explanatory variables input for each user, to calculate values of the components s₁, s₂, . . . , and sₙ of the vector y of the equation (3). In the present example, components of rows of the matrix X of the equation (3) are respectively x₁, x₂, and x₃. The estimation unit 4 assigns values of x₁, x₂, and x₃ of a user of the first prepaid mobile phone, values of x₁, x₂, and x₃ of a user of the second prepaid mobile phone, . . . , and values of x₁, x₂, and x₃ of a user of the n-th prepaid mobile phone, respectively to components of the first row of the matrix X, components of the second row of the matrix X, . . . , and components of the n-th row of the matrix X of the equation (3), to calculate the values of the components s₁, s₂, . . . , and sₙ of the vector y of the equation (3). The s₁, s₂, . . . , and sₙ are the objective variables representing the genders of the respective users of the prepaid mobile phones, so that the values of the s₁, s₂, . . . , and sₙ calculated represent estimated values of the genders of the respective users of the prepaid mobile phones. In the present example, in a case where the value of the objective variable, such as the s₁, is “1”, it means that the user is male, and in a case where the value is “−1”, it means that the user is female.

The estimation result storage unit 5 is a storage device that stores the demographic information about the user of the prepaid mobile phone estimated by the estimation unit 4. The estimation unit 4 stores the user ID of the user of the prepaid mobile phone and the estimation results of the age and gender in association with each other, in the estimation result storage unit 5.

The learning unit 2 and the estimation unit 4 are realized by, for example, a CPU of a computer that operates in accordance with a user information estimation program. In this case, the CPU only needs to read the user information estimation program from a program recording medium, for example, a program storage device of the computer (not illustrated in FIG. 1), to operate as the learning unit 2 and the estimation unit 4 in accordance with the user information estimation program. In addition, the learning unit 2 and the estimation unit 4 may be realized by separate pieces of hardware.

In addition, the user information estimation system 10 of the present invention may have a configuration in which two or more physically separated devices are connected together by wire or wirelessly. The same applies to the exemplary embodiment described later.

Next, processing progress of the present invention will be described. FIG. 2 is a flowchart illustrating an example of processing progress of the first exemplary embodiment of the present invention. It is assumed that, in the training data storage unit 1, a set of information in which the user ID and the age and gender, which are obtained for many users of the postpaid mobile phones, are associated with each other, and a set of information in which the user ID and the value of the item corresponding to each of the explanatory variables (in the present example, the “number of voice calls in the past month”, the “voice call duration in the past month”, and the “number of mail transmissions in the past month”) are associated with each other, are stored as the training data in advance.

The learning unit 2 generates the estimation model by machine learning, on the basis of the training data stored in the training data storage unit 1 (step S1). In the present example, it is assumed that the learning unit 2 generates the estimation model with the “age” as the objective variable, and the estimation model with the “gender” as the objective variable. In addition, it is assumed that the estimation model with the “age” as the objective variable is expressed by the equation (1), and the estimation model with the “gender” as the objective variable is expressed by the equation (3).

The learning unit 2 stores the estimation model generated, in the estimation model storage unit 3.

Next, for each user of the prepaid mobile phone for which the age and gender are estimated, the user ID and the values of the explanatory variables (the “number of voice calls in the past month”, the “voice call duration in the past month”, and the “number of mail transmissions in the past month”) are input to the estimation unit 4. The user ID and the explanatory variables representing the information indicating such status of use can be extracted from the CDR data retained by the communication carrier.

The estimation unit 4 applies, to the estimation model, the values of the explanatory variables of the users of the prepaid mobile phones input, to estimate the age and gender of the user of the prepaid mobile phone (step S2). In step S2, the estimation unit 4 assigns the values of the explanatory variables of the users of the prepaid mobile phones for one user, for each row of the matrix X of the equation (1), to calculate the values of the components a₁, a₂, . . . , and aₙ of the vector y of the equation (1). The values of the a₁, a₂, . . . , and aₙ are the estimated values of the ages of the respective users of the prepaid mobile phones. Similarly, the estimation unit 4 assigns the values of the explanatory variables of the users of the prepaid mobile phones for one user, for each row of the matrix X of the equation (3), to calculate the values of the components s₁, s₂, . . . , and sₙ of the vector y of the equation (3). The values of the s₁, s₂, . . . , and sₙ are the estimated values of the respective users of the prepaid mobile phones. As described above, in a case where the value, such as the s₁, is “1”, it means that the user is male, and in a case where the value is “−1”, it means that the user is female.

The estimation unit 4 stores, in the estimation result storage unit 5, the user ID of the user of the prepaid mobile phone, and the estimation results of the age and gender of the user in association with each other.

According to the present exemplary embodiment, on the basis of the age and gender of the user of the postpaid mobile phone whose age and gender are known, and the information indicating the status of use of the mobile phone by the user, the learning unit 2 generates the estimation model indicating a relationship between the objective variable (the age and gender) and the explanatory variable (the information indicating the status of use). Then, the estimation unit 4 applies the information indicating the status of use by the user of the prepaid mobile phone to the estimation model, to calculate the estimated values of the age and gender of the user of the prepaid mobile phone. Therefore, according to the present exemplary embodiment, the age and gender of the user of the prepaid mobile phone can be estimated.

### Second Exemplary Embodiment

FIG. 3 is a block diagram illustrating an example of a user information estimation system of a second exemplary embodiment of the present invention. The same components as those in the first exemplary embodiment are denoted by the same reference numerals as those in FIG. 1, and a description thereof will be omitted. A user information estimation system 10 of the present exemplary embodiment includes a training data storage unit 1, a learning unit 2, an estimation model storage unit 3, an estimation unit 4, an estimation result storage unit 5, a base station related information generation unit 6, and a base station related information storage unit 7, The training data storage unit 1, the learning unit 2, the estimation model storage unit 3, the estimation unit 4, and the estimation result storage unit 5 are the same as the training data storage unit 1, the learning unit 2, the estimation model storage unit 3, the estimation unit 4, and the estimation result storage unit 5 in the first exemplary embodiment.

In the following description, it is assumed that the learning unit 2 and the estimation unit 4 execute the processing described in the first exemplary embodiment, and as a result, information in which a user ID of a user of a prepaid mobile phone and an estimation result of the age and gender of the user are associated with each other, is stored in the estimation result storage unit 5.

A communication log of each base station is input to the base station related information generation unit 6. The communication log is generated for each base station. In a communication log, a user ID of a user of a mobile phone that has communicated with a base station that has generated the communication log, and time when the base station and the mobile phone has communicated with each other (hereinafter, referred to as time of communication), and a base station ID of the base station, are recorded in association with each other.

The base station related information generation unit 6 uses the user ID stored in the estimation result storage unit 5 (the user ID of the user of the prepaid mobile phone) as a key, to extract the time of communication and the base station ID associated with the user ID, from the communication log of each base station. The base station related information generation unit 6 further generates information in which the time of communication and the base station ID, the user ID used as the key, and demographic information (specifically the age and gender) about the user of the prepaid mobile phone stored in the estimation result storage unit 5 in association with the user ID, are associated with each other. That is, the base station related information generation unit 6 generates information in which the user ID of the user of the prepaid mobile phone, the age and gender of the user, the time of communication between the prepaid mobile phone of the user and the base station, and the base station ID of the base station, are associated with each other. Hereinafter, the information is referred to as base station related information.

The base station related information generation unit 6 generates for each set of the time of communication and the base station ID extracted from the communication log.

The base station related information storage unit 7 is a storage device that stores the base station related information. The base station related information generation unit 6 stores the base station related information generated, in the base station related information storage unit 7.

The learning unit 2, the estimation unit 4, and the base station related information generation unit 6 are realized by, for example, a CPU of a computer that operates in accordance with a user information estimation program. In this case, the CPU only needs to read the user information estimation program from a program recording medium, for example, a program storage device of the computer (not illustrated in FIG. 3), to operate as the learning unit 2, the estimation unit 4, and the base station related information generation unit 6 in accordance with the user information estimation program. In addition, the learning unit 2, the estimation unit 4, and the base station related information generation unit 6 may be realized by separate pieces of hardware.

Also in the present exemplary embodiment, the user information estimation system 10 executes the processing of steps S1 and S2 described in the first exemplary embodiment. As a result, information in which the user ID of the user of the prepaid mobile phone and the estimation result of the age and gender of the user are associated with each other, is stored in the estimation result storage unit 5. After that, on the basis of the communication log of each base station input, and the information stored in the estimation result storage unit 5, the base station related information generation unit 6 generates base station related information, and stores the base station related information in the base station related information storage unit 7.

Also in the present exemplary embodiment, the same effect as that of the first exemplary embodiment can be obtained. In addition, according to the present exemplary embodiment, the base station related information can be obtained that is information in which the user ID of the user of the prepaid mobile phone, the demographic information about the user (age and gender), the time of communication between the prepaid mobile phone of the user and the base station, and the base station ID of the base station, are associated with each other. The communication carrier can grasp a location of the base station identified by the base station ID. Therefore, it is possible to grasp, from the base station related information, where, when, and how old the user is, and also possible to grasp the gender of the user.

Incidentally, in a case where the estimation unit 4 estimates only the age, the base station related information does not have to include information about the age. In addition, in a case where the estimation unit 4 estimates only the gender, the base station related information does not have to include information about the gender.

In the second exemplary embodiment, a case has been shown in which the user information estimation system associates the demographic information estimated, and the information extracted from the communication log of the base station with each other. The user information estimation system may associate the demographic information estimated, with terminal information and average revenue per user (ARPU) that can be acquired from customer relationship management (CRM). In addition, in a case where the carrier introduces deep packet inspection (DPI), the user information estimation system may associate the demographic information estimated and information that can be acquired from the DPI (for example, URL accessed by the user) with each other.

Incidentally, the user information estimation system 10 described in the above exemplary embodiments is used by, for example, the communication carrier; however, a person other than the communication carrier may use the user information estimation system 10. In that case, a user of the user information estimation system 10 only needs to receive, from the communication carrier, provision of training data, information input to the estimation unit 4, the communication log, information indicating a relationship between the base station ID and the location of the base station, and the like.

Incidentally, a service by the user information estimation system of the present invention can be provided in a form of Software as a Service (SaaS).

In addition, the user information estimation system 10 described in the above exemplary embodiments may be divided into separate systems, an independent system including components related to learning (hereinafter, referred to as a learning system) and an independent system including components related to estimation (hereinafter, referred to as an estimation system), and the learning system and the estimation system may be respectively used by different persons.

FIG. 4 is a block diagram illustrating an example of the learning system. The same components as those illustrated in FIG. 1 are denoted by the same reference numerals as those in FIG. 1. The learning system includes the training data storage unit 1, the learning unit 2, and the estimation model storage unit 3.

The training data storage unit 1 stores the training data similar to the training data in the first exemplary embodiment and the second exemplary embodiment.

On the basis of information indicating a status of use of a user of a postpaid mobile phone, and demographic information about the user of the postpaid mobile phone (in other words, on the basis of the training data), the learning unit 2 generates an estimation model with demographic information as an objective variable, and information indicating a status of use as an explanatory variable. Specific operation of the learning unit 2 is the same as that of the learning unit 2 in the first exemplary embodiment and the second exemplary embodiment.

The estimation model storage unit 3 is a storage device that stores the estimation model. The learning unit 2 stores the estimation model generated, in the estimation model storage unit 3.

FIG. 5 is a block diagram illustrating an example of the estimation system. The same components as those illustrated in FIG. 1 are denoted by the same reference numerals as those in FIG. 1. The estimation system includes the estimation unit 4, and the estimation result storage unit 5.

The estimation model generated by the learning system (see FIG. 4) is input to the estimation unit 4. In addition, information indicating a status of use of the user of the prepaid mobile phone (in other words, a value of the explanatory variable) is input to the estimation unit 4. The estimation unit 4 applies the information indicating the status of use to the estimation model, to calculate an estimated value of the demographic information about the user of the prepaid mobile phone. Specific operation of the estimation unit 4 is the same as that of the estimation unit 4 in the first exemplary embodiment and the second exemplary embodiment.

The estimation result storage unit 5 is the same as the estimation result storage unit 5 in the first exemplary embodiment and the second exemplary embodiment.

The estimation system illustrated in FIG. 5 may include the base station related information generation unit 6 and the base station related information storage unit 7 in the second exemplary embodiment.

In addition, in the above description, a case has been shown in which information relating to a postpaid mobile terminal (for example, information indicating a status of use) and demographic information about a user of the postpaid mobile terminal are used as the training data. The information used as the training data is not limited to the information relating to the postpaid mobile terminal, and only needs to be information relating to a mobile terminal in which demographic information is known. That is, it is sufficient that the information relating to the mobile terminal in which demographic information about the user is known, and the demographic information are used as the training data.

FIG. 6 is a schematic block diagram illustrating a configuration example of the computer according to exemplary embodiments of the present invention. A computer 1000 includes a CPU 1001, a main storage device 1002, an auxiliary storage device 1003, an interface 1004, and an input device 1006. Input data to the estimation unit 4 and input data to the base station related information generation unit 6 are input to the input device 1006.

The user information estimation system 10 of each exemplary embodiment is implemented in the computer 1000. Operation of the user information estimation system 10 is stored in the auxiliary storage device 1003, in a form of a program (user information estimation program). The CPU 1001 reads the program from the auxiliary storage device 1003, and deploys the program on the main storage device 1002, and then executes the processing described above in accordance with the program.

The auxiliary storage device 1003 is an example of a non-transitory tangible medium. Other examples of the non-transitory tangible medium include a semiconductor memory, DVD-ROM, CD-ROM, a magneto-optical disk, and a magnetic disk connected via the interface 1004. In addition, when the program is delivered to the computer 1000 via a communication line, the computer 1000 to which the program is delivered may deploy the program on the main storage device 1002 to execute the processing described above.

In addition, the program may be the one for partially realizing the processing described above. Further, the program may be a differential program that realizes the above-described processing in combination with another program already stored in the auxiliary storage device 1003.

Next, an outline of the present invention will be described. FIG. 7 is a block diagram illustrating an outline of the user information estimation system of the present invention. The user information estimation system of the present invention includes an estimation model generation means 21, and an estimation means 22.

The estimation model generation means 21 (for example; the learning unit 2) generates, on the basis of information relating to a mobile terminal in which demographic information about a user is known, and the demographic information, an estimation model with demographic information as an objective variable, and information relating to a mobile terminal as an explanatory variable.

The estimation means 22 (for example, the estimation unit 4) applies information relating to a prepaid mobile terminal to the estimation model, to calculate an estimated value of demographic information about a user of the prepaid mobile terminal.

With such a configuration, the demographic information about the user of the prepaid mobile terminal can be estimated.

In addition, the estimation model generation means 21 may generate, on the basis of the information relating to the postpaid mobile terminal, and the demographic information about the user of the postpaid mobile terminal, an estimation model with demographic information as an objective variable, and information relating to a mobile terminal as an explanatory variable.

In addition, the estimation model generation means 21 may generate, on the basis of information indicating a status of use of a mobile terminal in which demographic information about a user is known, and the demographic information, an estimation model with demographic information as an objective variable, and information indicating the status of use as an explanatory variable, and the estimation means 22 may apply information indicating a status of use of a prepaid mobile terminal to the estimation model, to calculate an estimated value of demographic information about a user of the prepaid mobile terminal.

In addition, the user information estimation system may have a configuration including an information generation means (for example, the base station related information generation unit 6) that generates, on the basis of a communication log of a base station, and an estimated value of demographic information of a user of each prepaid mobile terminal, information (for example, the base station related information) in which identification information of a base station, identification information of a user of a prepaid mobile terminal that has communicated with the base station, time when the base station and the prepaid mobile terminal have communicated with each other, and an estimated value of demographic information about the user are associated with each other.

For example, the estimation model generation means 21 generates one or both of an estimation model with age as an objective variable, and an estimation model with gender as an objective variable.

In the above, the present invention has been described with reference to the exemplary embodiments; however, the present invention is not limited to the exemplary embodiments described above. Various modifications that can be understood by those skilled in the art within the scope of the present invention can be made to the configuration and details of the present invention.

This application claims priority based on U.S. provisional application No. 62/201,647 filed on Aug. 6, 2015, the disclosure of which is incorporated herein in its entirety.

### INDUSTRIAL APPLICABILITY

The present invention is suitably applied to the user information estimation system that estimates the demographic information about the user of the prepaid mobile terminal.

### REFERENCE SIGNS LIST

1 Training data storage unit
2 Learning unit
3 Estimation model storage unit
4 Estimation unit
5 Estimation result storage unit
6 Base station related information generation unit
7 Base station related information storage unit
10 User information estimation system

1. A user information estimation system comprising:
an estimation model generation unit that generates, on the basis of information relating to a mobile terminal in which demographic information about a user is known, and the demographic information, an estimation model with demographic information as an objective variable, and information relating to a mobile terminal as an explanatory variable; and
an estimation unit that applies information relating to a prepaid mobile terminal to the estimation model, to calculate an estimated value of demographic information about a user of the prepaid mobile terminal.

2. The user information estimation system according to claim 1, wherein
the estimation model generation unit generates, on the basis of information relating to a postpaid mobile terminal, and demographic information about a user of the postpaid mobile terminal, an estimation model with demographic information as an objective variable, and information relating to a mobile terminal as an explanatory variable.

3. The user information estimation system according to claim 1, wherein
the estimation model generation unit generates, on the basis of information indicating a status of use of a mobile terminal in which demographic information about a user is known, and the demographic information, an estimation model with demographic information as an objective variable, and information indicating the status of use as an explanatory variable, and
the estimation unit applies information indicating a status of use of a prepaid mobile terminal to the estimation model, to calculate an estimated value of demographic information about a user of the prepaid mobile terminal.

4. The user information estimation system according to claim 1, further comprising
an information generation unit that generates, on the basis of a communication log of a base station, and an estimated value of demographic information about a user of each prepaid mobile terminal, information in which identification information of a base station, identification information of a user of a prepaid mobile terminal that has communicated with the base station, time when the base station and the prepaid mobile terminal have communicated with each other, and an estimated value of demographic information about the user are associated with each other.

5. The user information estimation system according to claim 1, wherein
the estimation model generation unit generates one or both of an estimation model with age as an objective variable, and an estimation model with gender as an objective variable.

6. A user information estimation method comprising:
generating, on the basis of information relating to a mobile terminal in which demographic information about a user is known, and the demographic information, an estimation model with demographic information as an objective variable, and information relating to a mobile terminal as an explanatory variable; and
applying information relating to a prepaid mobile terminal to the estimation model, to calculate an estimated value of demographic information about a user of the prepaid mobile terminal.

7. The user information estimation method according to claim 6, comprising
generating, on the basis of information relating to a postpaid mobile terminal, and demographic information about a user of the postpaid mobile terminal, an estimation model with demographic information as an objective variable, and information relating to a mobile terminal as an explanatory variable.

8. The user information estimation method according to claim 6, comprising:
generating, on the basis of information indicating a status of use of a mobile terminal in which demographic information about a user is known, and the demographic information, an estimation model with demographic information as an objective variable, and information indicating the status of use as an explanatory variable, and
applying information indicating a status of use of a prepaid mobile terminal to the estimation model, to calculate an estimated value of demographic information about a user of the prepaid mobile terminal.

9. The user information estimation method according to claim 6, further comprising
generating, on the basis of a communication log of a base station, and an estimated value of demographic information about a user of each prepaid mobile terminal, information in which identification information of a base station, identification information of a user of a prepaid mobile terminal that has communicated with the base station, time when the base station and the prepaid mobile terminal have communicated with each other, and an estimated value of demographic information about the user are associated with each other.

10. A non-transitory computer-readable recording medium in which a user information estimation program is recorded,
the user information estimation program causing a computer to execute:
estimation model generation processing that generates, on the basis of information relating to a mobile terminal in which demographic information about a user is known, and the demographic information, an estimation model with demographic information as an objective variable, and information relating to a mobile terminal as an explanatory variable; and
estimation processing that applies information relating to a prepaid mobile terminal to the estimation model, to calculate an estimated value of demographic information about a user of the prepaid mobile terminal.

11. The non-transitory computer-readable recording medium according to claim 10, the user information estimation program causing
a computer to
generate, on the basis of information relating to a postpaid mobile terminal, and demographic information about a user of the postpaid mobile terminal, an estimation model with demographic information as an objective variable, and information relating to a mobile terminal as an explanatory variable, in the estimation model generation processing.

12. The non-transitory computer-readable recording medium according to claim 10, the user information estimation program causing
a computer to:
generate, on the basis of information indicating a status of use of a mobile terminal in which demographic information about a user is known, and the demographic information, an estimation model with demographic information as an objective variable, and information indicating the status of use as an explanatory variable, in the estimation model generation processing; and
apply information indicating a status of use of a prepaid mobile terminal to the estimation model, to calculate an estimated value of demographic information about a user of the prepaid mobile terminal, in the estimation processing.

13. The non-transitory computer-readable recording medium according to claim 10, the user information estimation program causing
a computer to
execute information generation processing that generates, on the basis of a communication log of a base station, and an estimated value of demographic information about a user of a prepaid mobile terminal, information in which identification information of a base station, identification information of a user of a prepaid mobile terminal that has communicated with the base station, time when the base station and the prepaid mobile terminal have communicated with each other, and an estimated value of demographic information about the user are associated with each other.
